(19) United States
(12) Patent Application Publication
(10) Pub. No.: US 2026/0318131 A1
(43) Pub. Date: Oct. 15, 2026

(54) LIFTGATE LATCH DETENT SWITCH LEVER

(71) Applicant: STRATTEC SECURITY CORPORATION, Milwaukee, WI (US)

(72) Inventors: Michael Carleton Strole, Lake Orion, MI (US); Bryan Raymond Stolla, Commerce Twp, MI (US); Walter Joseph Steiner, Rochester, MI (US); Ian Martin, Waterford, MI (US); Benjamin Frank Chase, Waterford, MI (US)

(21) Appl. No.: 19/467,322

(22) Filed: Feb. 2, 2026

Related U.S. Application Data
(60) Provisional application No. 63/757,627, filed on Feb. 12, 2025.

(51) Int. Cl. E05B 85/26; E05B 85/24; E05B 83/18

(52) U.S. Cl. CPC E05B 85/26; E05B 85/243; E05B 83/18

(57) ABSTRACT

A latch assembly includes a forkbolt biased to rotate in a first direction about a first pivot point, and a detent biased to rotate in a second direction about a second pivot point. The detent engages with the forkbolt in at least two different positions. The latch assembly further includes a detent switch and a pivoting detent switch lever. The detent switch lever includes a first detent switch lever engagement surface configured to engage the detent switch during at least one rotational positioned of the detent switch lever, a second detent switch lever engagement surface configured to engage the detent during at least one rotational position of the detent switch lever, and a third detent switch lever engagement surface configured to engage the forkbolt during at least one rotational position of the detent switch lever.

### CROSS-REFERENCE TO RELATED APPLICATIONS

This application claims priority to U.S. Provisional Patent Application No. 63/757,627, filed Feb. 12, 2025, the entire contents of which are incorporated herein by reference.

### FIELD

The present disclosure relates to latch assemblies, and more specifically latch assemblies for motor vehicles.

### BACKGROUND

Many current motor vehicles include compartments (e.g., hoods, rear compartments, liftgates) that are latched with latch assemblies. The latch assemblies enable an operator to push down on the compartment, and to have the compartment latched and locked in place until the operator desires to unlatch the compartment. U.S. Patent No. 11,332,964, the entire contents of which are incorporated herein by reference, discloses examples of various such types of latch assemblies.

### SUMMARY

In accordance with one example, a latch assembly includes a forkbolt biased to rotate in a first direction about a first pivot point, and a detent biased to rotate in a second direction about a second pivot point. The detent engages with the forkbolt in at least two different positions. The latch assembly further includes a detent switch and a pivoting detent switch lever. The detent switch lever includes a first detent switch lever engagement surface configured to engage the detent switch during at least one rotational positioned of the detent switch lever, a second detent switch lever engagement surface configured to engage the detent during at least one rotational position of the detent switch lever, and a third detent switch lever engagement surface configured to engage the forkbolt during at least one rotational position of the detent switch lever.

In accordance with another example, a latch assembly includes a forkbolt biased to rotate in a first direction about a first pivot point, and a detent biased to rotate in a second direction about a second pivot point. The detent engages with the forkbolt in at least two different positions. The latch assembly further includes a detent switch and a detent switch lever. The detent switch lever is configured to selectively engage at least one of the detent switch, the forkbolt, and the detent based on a rotational position of the pivoting detent switch lever. The latch assembly has an open position corresponding to a first rotational position of the forkbolt, a secondary position corresponding to a second rotational position of the forkbolt, and a primary position corresponding to a third rotational position of the forkbolt. The detent is rotated about the second pivot point at a first angle when the latch assembly is in the secondary position and at a second angle when the latch assembly is in the primary position, and the first angle is equal to the second angle.

Other features and aspects of the disclosure will become apparent by consideration of the following detailed description and accompanying drawings.

### BRIEF DESCRIPTION OF THE DRAWINGS

FIG. 1 is a schematic, cross-sectional view of a latch assembly according to one example, illustrating an open position.

FIG. 2 is a schematic, cross-sectional view of the latch assembly of FIG. 1, illustrating a secondary position.

FIG. 3 is a schematic, cross-sectional view of the latch assembly of FIG. 1, illustrating a primary position.

FIG. 4 is a schematic, cross-sectional view of the latch assembly of FIG. 1, illustrating a detent cushion and also an engagement depth associated with the latch assembly.

FIG. 5 is a schematic, cross-sectional view of another latch assembly, illustrating a different engagement depth that is different than the engagement depth of the latch assembly of FIG. 1.

FIG. 6 is a schematic, cross-sectional view of a latch assembly according to another example.

FIG. 7 is a schematic, cross-sectional view of the latch assembly of FIG. 6, illustrating an open position.

FIG. 8 is a schematic, cross-sectional view of the latch assembly of FIG. 6, illustrating a secondary position.

FIG. 9 is a schematic, cross-sectional view of the latch assembly of FIG. 6, illustrating a primary position.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

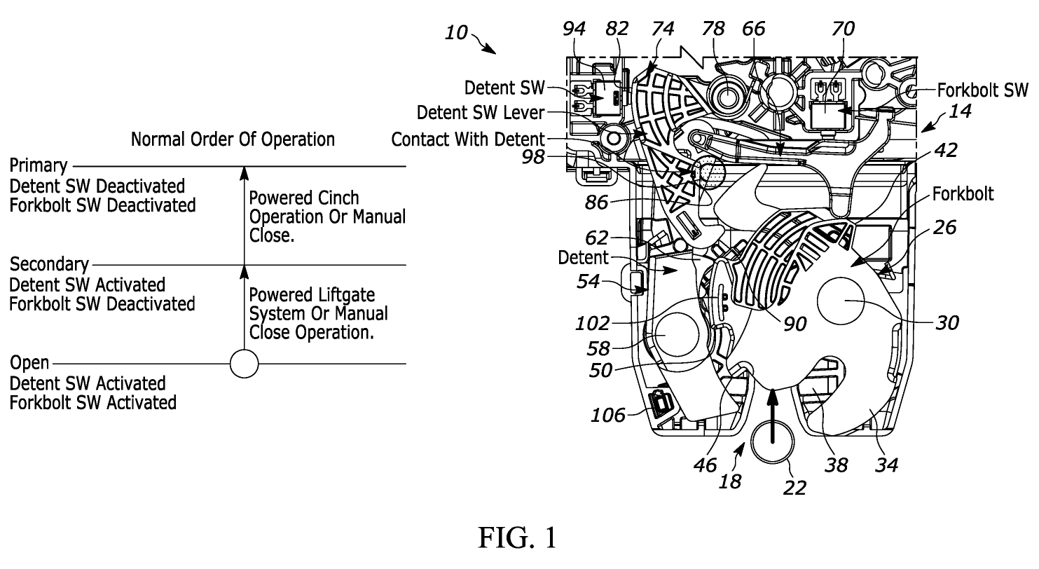

FIGS. 1-4 illustrate a latch assembly 10. The latch assembly 10 is primarily intended for use with a commercial motor vehicle (e.g., sedan, SUV, minivan, truck, etc.) for a cinching liftgate latch (e.g., a rear compartment latch). The latch assembly 10, however, may also be used for latching other components and/or with other types of machines or vehicles where a latch assembly 10 might be beneficial.

With continued reference to FIGS. 1-4, the latch assembly 10 includes a housing 14 defining a fishmouth (i.e., slot) 18 that is sized and shaped to receive a striker 22 of a compartment of a motor vehicle. The housing 14 may have shapes and sizes other than that illustrated. In some examples, the housing 14 is coupled (e.g., fixed) directly to an interior of a motor vehicle, adjacent a compartment of the motor vehicle. In other examples, the housing 14 is coupled to another area or areas of a vehicle or other structure.

The latch assembly 10 further includes a forkbolt (i.e., catch) 26 disposed at least partially within the housing 14. The forkbolt 26 rotates about a forkbolt pivot point 30 (e.g., pin) in the housing 14. In the illustrated example, the forkbolt 26 is biased (e.g., with a torsion spring or other biasing element) to rotate counterclockwise about the forkbolt pivot point 30, although other examples include different rotational directions or movements of the forkbolt 26, as well as different biasing elements to bias the forkbolt 26.

As illustrated in FIG. 1, the forkbolt 26 includes a forkbolt main arm 34 that defines a slot 38 to receive the striker 22. The forkbolt also includes a first forkbolt engagement surface 42, a first forkbolt latching projection 46, and a second forkbolt latching projection 50. Other examples of the forkbolt 26 include other numbers and arrangements of arms, surfaces, and latching projections than that illustrated.

With reference to FIGS. 1-4, the latch assembly 10 further includes a detent (i.e., pawl) 54 disposed at least partially within the housing 14. The detent 54 rotates about a detent pivot point 58 (e.g., pin) in the housing 14. In the illustrated example, the detent 54 is biased (e.g., with a torsion spring or other biasing element) to rotate clockwise about the detent pivot point 58, although other examples include different rotational directions or movement of the detent 54, as well as different biasing elements to bias the detent 54. In some examples, the detent 54 may be coupled for example, to a wire, cable, or other structure, which may be pulled to rotate the detent 54 against the biasing force (e.g., in a counterclockwise direction). In the illustrated example, the detent 54 includes a detent latching projection 62 that is sized and shaped to engage the first forkbolt latching projection 46 and the second forkbolt latching projection 50 during different operating conditions of the latch assembly 10 (e.g., rotational positions of the forkbolt 26).

The latch assembly 10 further includes a forkbolt switch lever 66 disposed at least partially within the housing 14. The forkbolt switch lever 66 is coupled (e.g., pivotally coupled) at one end of the forkbolt switch lever 66 to the detent 54, and is moved (e.g., translated laterally) by the detent 54 during operation of the latch assembly 10. As seen in FIGS. 1-4, a portion (e.g., protrusion) of the forkbolt switch lever 66 is sized and shaped to directly engage the first forkbolt engagement surface 42 during at least one operating condition of the latch assembly 10 (e.g., rotational position of the forkbolt 26).

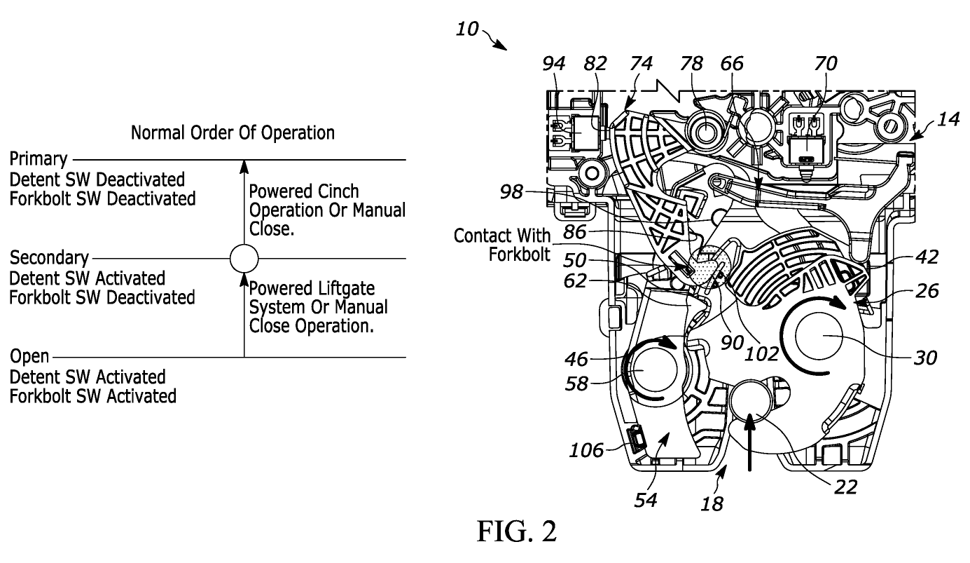

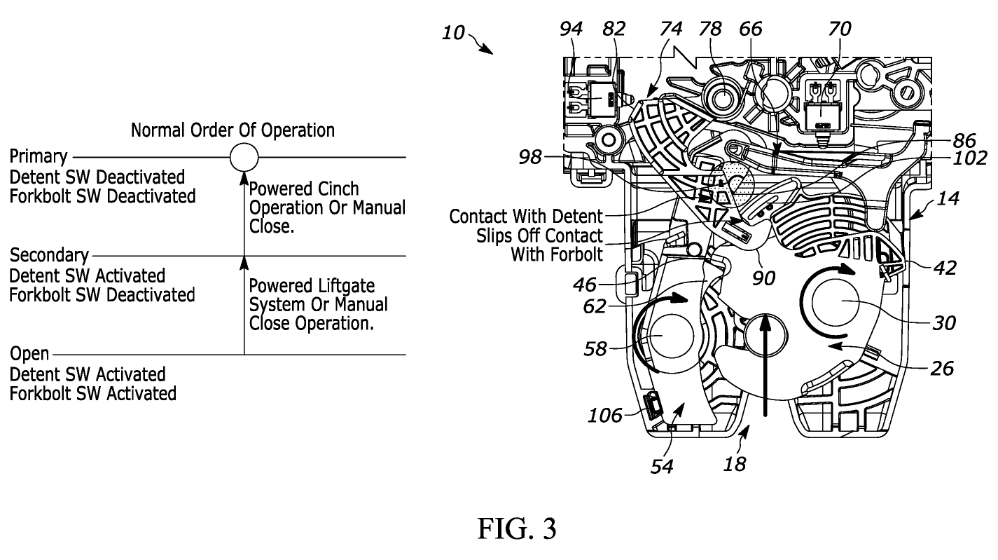

With continued reference to FIGS. 1-4, the latch assembly 10 further includes a forkbolt switch 70 (e.g., microswitch) disposed at least partially within the housing 14 (e.g., on a printed circuit board within the housing 14 or mounted elsewhere within the housing 14). In some examples, the forkbolt switch 70 is positioned outside of the housing 14. The term “switch” as used herein may include, for example, any type of sensor (e.g., pushbutton sensor, proximity sensor (inductive or capacitive), or other type of sensor). The forkbolt switch 70 is positioned such that during a certain rotational position or positions of the forkbolt 26 (e.g., as seen in FIG. 1), the forkbolt switch lever 66 presses against or is otherwise brought into close proximity to the forkbolt switch 70 (e.g., to activate or otherwise transition the forkbolt switch 70), whereas during another rotational position or positions of the forkbolt 26 (e.g., as seen in FIGS. 2 and 3), the forkbolt switch lever 66 is spaced away from the forkbolt switch 70 (e.g., to deactivate or otherwise transition the forkbolt switch 70).

The latch assembly 10 further includes a detent switch lever 74 disposed at least partially within the housing 14. The detent switch lever 74 is coupled (e.g., pivotally coupled) to the housing 14 at a pivot point 78 (e.g., pin or other structure on the housing 14). In some examples, the detent switch lever 74 is biased (e.g., with a torsion spring or other biasing element) to rotate about the pivot point 78 (e.g., counterclockwise in the illustrated example). As illustrated in FIGS. 1-3, the detent switch lever 74 includes a first detent switch lever engagement surface 82, a second detent switch lever engagement surface 86, and a third detent switch lever engagement surface 90. In some examples, the first detent switch lever engagement surface 82, the second detent switch lever engagement surface 86, and the third detent switch lever engagement surface 90 each form part of an exterior and/or periphery of the detent switch lever 74.

With continued reference to FIGS. 1-4, the latch assembly 10 further includes a detent switch 94 (e.g., microswitch) disposed at least partially within the housing 14 (e.g., on a printed circuit board within the housing 14 or mounted elsewhere within the housing 14). In some examples, the detent switch 94 is positioned outside of the housing 14. The detent switch 94 is positioned such that during a certain rotational position or positions of the detent switch lever 74 (e.g., as seen in FIGS. 1 and 2), the first detent switch lever engagement surface 82 presses against or is otherwise brought into close proximity to the detent switch 94 (e.g., to activate or otherwise transition the detent switch 94), whereas during another rotational position or positions of the detent switch lever 74 (e.g., as seen in FIG. 3), the first detent switch lever engagement surface 82 is spaced away from the detent switch 94 (e.g., to deactivate or otherwise transition the detent switch 94).

Overall, switches such as the forkbolt switch 70 and the detent switch 94 may be used, for example, to determine a position or positions of the forkbolt 26, the detent 54, the forkbolt switch lever 66, and/or the detent switch lever 74. The combined status (e.g., activated or deactivated, etc.) of the forkbolt switch 70 and the detent switch 94 may communicate a status of the overall latch assembly 10. For powered cinching liftgate latches, any next step in order of operation may be determined by a physical state of the latch assembly. Thus, there is a desire to detect what state the assembly is in. Switches such as the forkbolt switch 70 and the detent switch 94 (and also the forkbolt switch 338 and the detent switch 346 described further below) may be used for this purpose.

With continued reference to FIGS. 1-4, in the illustrated example the detent 54 includes a detent engagement surface 98 (e.g., forming part of a protrusion, bump, or other structure on the detent 54). The detent engagement surface 98 is shaped, sized, and positioned to be contacted by the second detent switch lever engagement surface 86 during at least one rotational position of the detent switch lever 74 (FIGS. 1 and 3), and is configured to be spaced away from the second detent switch lever engagement surface 86 during at least one other rotational position of the detent switch lever 74 (FIG. 2). In some examples, the detent engagement surface 98 acts as a stop for the detent switch lever 74, to limit or prevent rotation of the detent switch lever 74.

As illustrated in FIGS. 1-4, the forkbolt 26 includes a second forkbolt engagement surface 102 (e.g., forming part of a rail, rib, protrusion, or other structure on the forkbolt 26). The second forkbolt engagement surface 102 is shaped, sized, and positioned to be contacted by the third detent switch lever engagement surface 90 during at least one rotational position of the detent switch lever 74 (FIG. 2), and is configured to be space away from the third detent switch lever engagement surface 90 during at least one other rotational position of the detent switch lever 74 (FIGS. 1 and 3).

With reference to FIGS. 1-3, the latch assembly 10 may be moved between an open position (FIG. 1), a secondary position (FIG. 2), and a primary position (FIG. 3). In some examples, a powered liftgate system or manual operation may force the striker 22 into the fishmouth 18, causing the latch assembly 10 to move from the open position to the secondary position. A powered cinch operation or a manual close may then move the latch assembly 10 from the secondary position to the primary position. Other examples include different operations and/or conditions that move the latch assembly 10 between the open position, the secondary position, and the primary position.

With reference to FIG. 1, when the latch assembly 10 is in the open position, the forkbolt switch 70 and the detent switch 94 are both transitioned to a first state (e.g., an activated state, a deactivated state, or other state), to signify a physical state and status of the latch assembly 10. In this open position, the forkbolt switch lever 66 is pressed against or is otherwise brought into close proximity to the forkbolt switch 70, and the first detent switch lever engagement surface 82 pressed against or is otherwise brought into close proximity to the detent switch 94. In this open position, the second detent switch lever engagement surface 86 is also in contact with the detent engagement surface 98, and the third detent switch lever engagement surface 90 is spaced away from the second forkbolt engagement surface 102.

With reference to FIG. 2, the latch assembly 10 may be moved into the secondary position by moving the striker 22 farther upwardly, such that the striker 22 is captured by the forkbolt 26, and the forkbolt 26 is rotated (e.g., clockwise). When the latch assembly 10 is in the secondary position, and as seen in FIG. 2, the forkbolt switch 70 is transitioned to a second state (e.g., a deactivated state, an activated state, or other state), and the detent switch 94 is transitioned to the first state (e.g., the activated state, the deactivated state, or other state), to signify a different physical state and status of the latch assembly 10. In this secondary position, the forkbolt switch lever 66 is spaced away from the forkbolt switch 70, and the first detent switch lever engagement surface 82 remains pressed against or is otherwise in close proximity to the detent switch 94. As seen in FIG. 2, in some examples the continued activation of the detent switch 94 may occur because as the forkbolt 26 rotates (clockwise as seen in FIG. 2), the third detent switch lever engagement surface 90 is placed into engagement with the second forkbolt engagement surface 102.

With reference to FIG. 3, the latch assembly 10 may be moved into the primary position (e.g., via a cinching operation), and the forkbolt 26 may be rotated further (e.g., clockwise). When the latch assembly 10 is in the primary position, and as seen in FIG. 3, both the forkbolt switch 70 and the detent switch 94 are transitioned to the second state (e.g., the deactivated state, the activated state, or other state), to signify yet a different physical state and status of the latch assembly 10. In this primary position, the forkbolt switch lever 66 remains spaced away from the forkbolt switch 70, and the first detent switch lever engagement surface 82 moves away from the detent switch 94. As seen in FIG. 3, in the open position the third detent switch lever engagement surface 90 is moved out of engagement with the second forkbolt engagement surface 102.

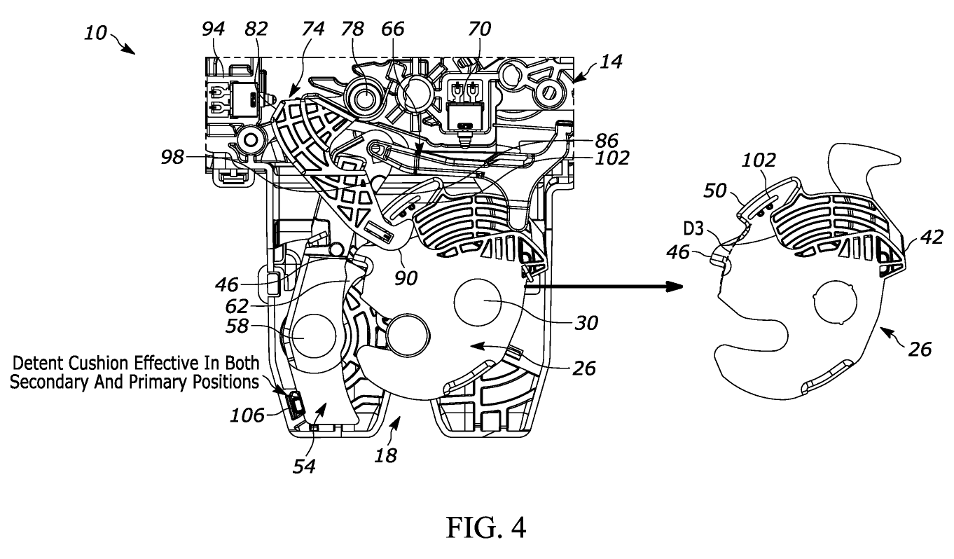

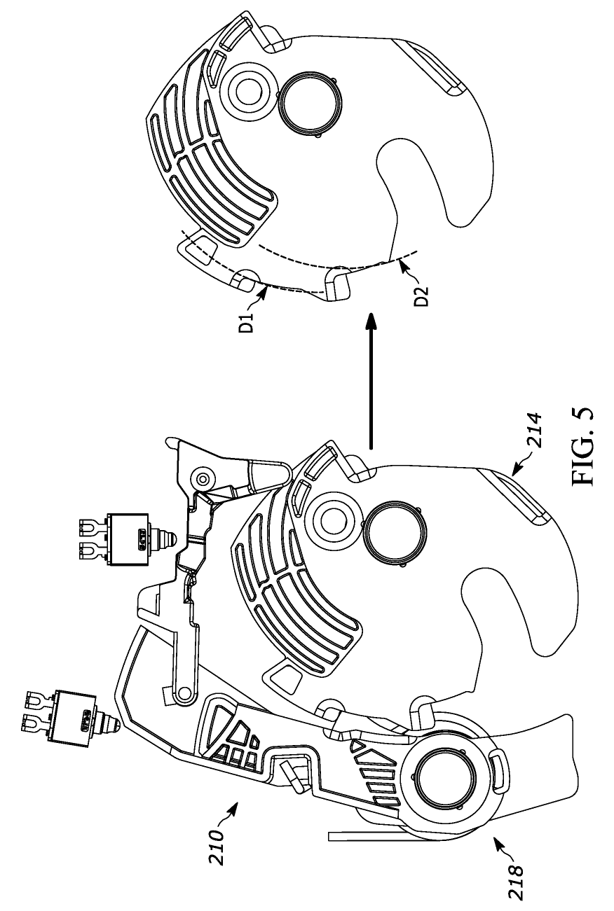

With reference to FIGS. 4 and 5, use of the separate detent switch lever 74 (and its associated detent switch 94) in the latch assembly 10 enables an engagement depth of the detent 54 to remain constant between the secondary and primary positions. The engagement depth of the detent 54 refers, for example, to how far the detent 54 rotates about the pivot point 58 and/or how far an end of the detent 54 extends relative to the forkbolt 26. FIG. 5 illustrates an example of a latch assembly 210 that does not include the detent switch lever 74. The latch assembly 210 includes a forkbolt 214 and a detent 218. As illustrated in FIG. 5, an upper end of the detent 218 extends to a first depth D1 at the secondary position, and a different (e.g., deeper) depth D2 during the primary position. Accordingly, the detent 218 is rotated to a different angle between the secondary position and the primary position. In contrast, with the latching system 10, the detent 54 rotates at the same angle relative to the detent pivot point 58 in both the secondary and the primary position, and thus to a same engagement depth D3 (FIG. 4).

The overall arrangement and use of the detent switch lever 74 (and its associated detent switch 94) may therefore permit the secondary and primary positions to be at the same engagement depth, while maintaining a required switch logic. The latch assembly 10 may be operated with the use of just the two switches (i.e., the forkbolt switch 70 and the detent switch 94), without the need for additional switches which may increase the overall size and/or complexity of the latch assembly 10.

In some examples, this arrangement may also permit the use of a smaller housing 14 and/or an overall smaller overall profile of the latch assembly 10. For example, because the detent 54 does not need to rotate out farther (as in FIG. 5), the overall space needed for the latch assembly 10 may be reduced compared to other latch assemblies.

In some examples, the addition of the detent switch lever 74 may also increase a latch engagement strength at the secondary position, because the engagement depth is just as deep as in the primary position.

Additionally, and with reference to FIGS. 1-4, the latch assembly 10 may further include a detent cushion 106, for use in both the secondary position and the primary position. In the illustrated example, the detent cushion 106 is positioned on the housing 14, and is positioned to contact and absorb impact from a lower end of the detent 54 when the lower end of the detent 54 is rotated. In some examples, the detent cushion 106 provides improved latching sound (e.g., reduced noise).

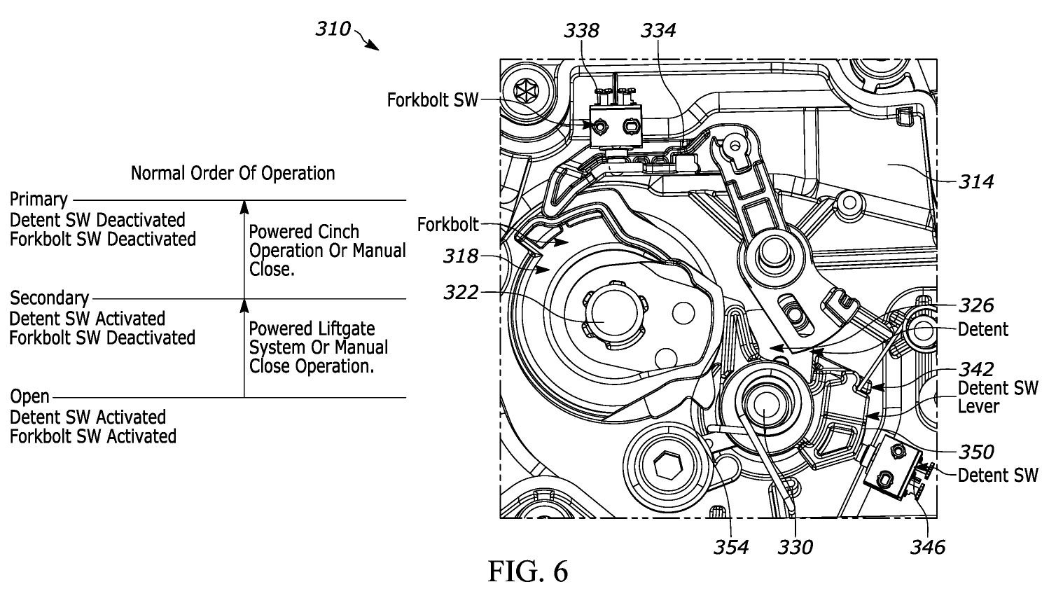

FIGS. 6-9 illustrate a latch assembly 310. The latch assembly 310 is primarily intended for use with a commercial motor vehicle (e.g., sedan, SUV, minivan, truck, etc.) for a tailgate lock. The latch assembly 310, however, may also be used for latching other components and/or with other types of machines or vehicles where a latch assembly 310 might be beneficial.

The latch assembly 310 is similar to the latch assembly 10 described above, and may include one or more similar or identical components to the latch assembly 10. In the illustrated example, the latch assembly 310 includes a housing 314. The housing 314 may have shapes and sizes other than that illustrated. In some examples, the housing 314 is coupled (e.g., fixed) directly to an interior of a motor vehicle, adjacent a compartment of the motor vehicle.

The latch assembly 310 further includes a forkbolt (i.e., catch) 318 disposed at least partially within the housing 314. The forkbolt 318 rotates about a forkbolt pivot point 322 (e.g., pin) in the housing 314. The latch assembly 310 further includes a detent (i.e., pawl) 326 disposed at least partially within the housing 314. The detent 326 rotates about a detent pivot point 330 (e.g., pin) in the housing 314.

With continued reference to FIGS. 6-9, the latch assembly 310 further includes a forkbolt switch lever 334 (e.g., disposed at least partially within the housing 314), and coupled to the detent 326 (e.g., through one or more linkages). The latch assembly 310 further includes a forkbolt switch 338 disposed at least partially within the housing 314 (e.g., on a printed circuit board within the housing 314 or mounted elsewhere within the housing 314 or outside of the housing 314). Similar to the forkbolt switch 70, the forkbolt switch 338 is positioned such that during a certain rotational position or positions of the forkbolt 318, the forkbolt switch lever 334 presses against or is otherwise brought into close proximity to the forkbolt switch 338 (e.g., to activate or otherwise transition the forkbolt switch 338), whereas during another rotational position or positions of the forkbolt 318, the forkbolt switch lever 334 is spaced away from the forkbolt switch 338 (e.g., to deactivate or otherwise transition the forkbolt switch 338).

The latch assembly 310 further includes a detent switch lever 342 (e.g., disposed at least partially within the housing 314), and a detent switch 346 (e.g., located on a printed circuit board within the housing 314 or mounted elsewhere within the housing 314 or outside of the housing 314). The detent switch lever 342 is coupled (e.g., pivotally coupled) to the housing 314 at the same pivot point 330 as the detent 326. This is in contrast to the latch assembly 10 described above, where the detent 54 rotates about a first pivot point 58, and the detent latch 74 rotates about a second, different pivot 78 spaced away from the first pivot point 54. Using the same pivot point 330 may be advantageous, for example, in a tailgate latch to maintain an overall smaller size of the latch assembly 310. In some examples, the detent switch lever 342 is biased (e.g., with a torsion spring or other biasing element) to rotate about the detent pivot point 330. Additionally, and similar to the latch assembly 10, the latch assembly 310 may use only two the switches (i.e., the forkbolt switch 338 and the detent switch 346), without the need for further switches that may increase the size and/or complexity of the overall latch assembly 310.

With continued reference to FIGS. 6-9, the detent switch lever 342 may also include various engagement surfaces that engage or disengage with the forkbolt 318, the detent 326, and/or the detent switch 346. In the illustrated example, the detent switch lever 342 includes a first detent switch lever engagement surface 350 that engages and disengages with the detent switch 346, and a second detent switch lever engagement surface 354 that engages and disengages with the forkbolt 318 (e.g., with an engagement surface of the forkbolt 318).

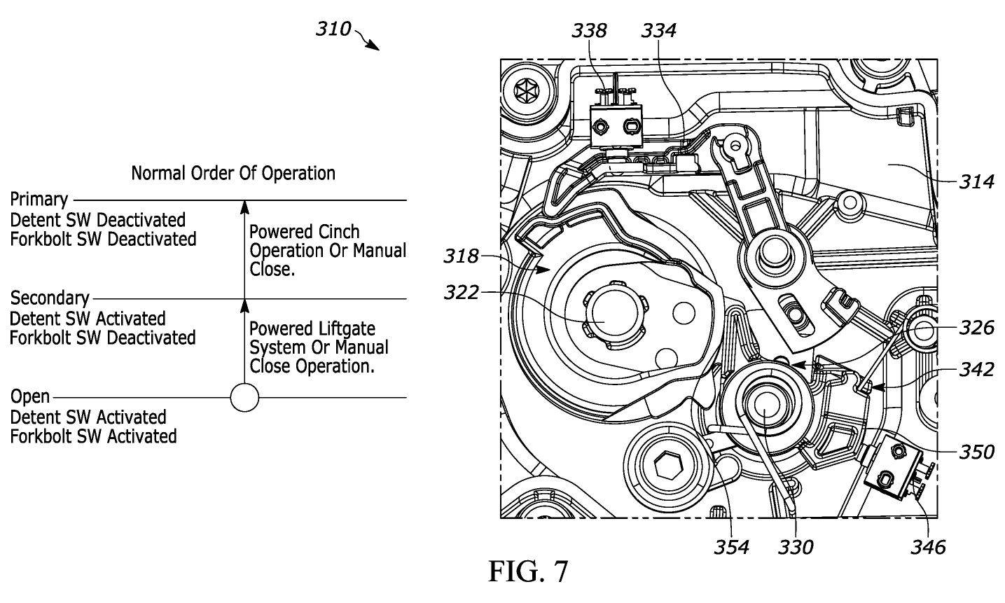

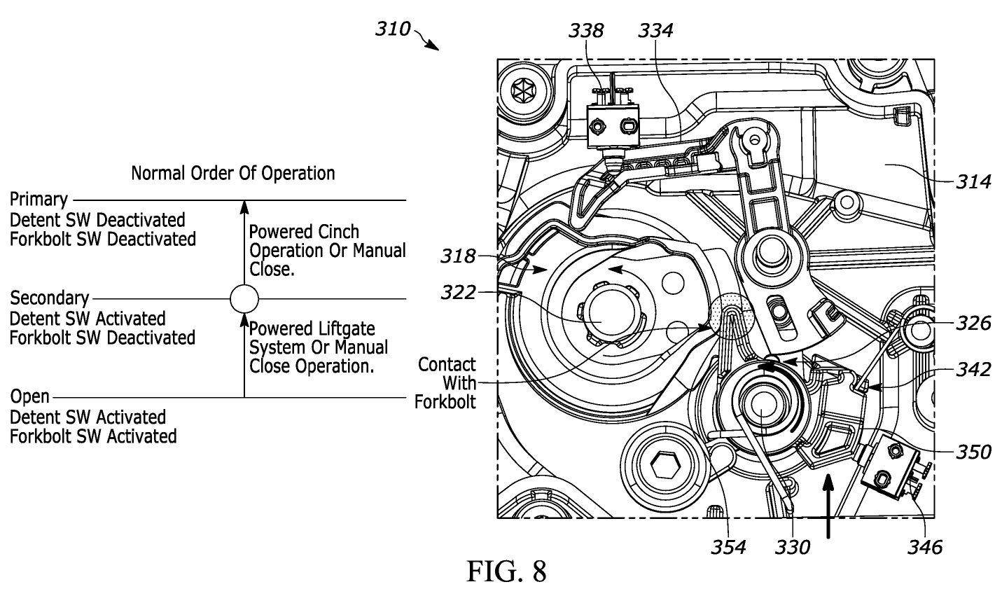

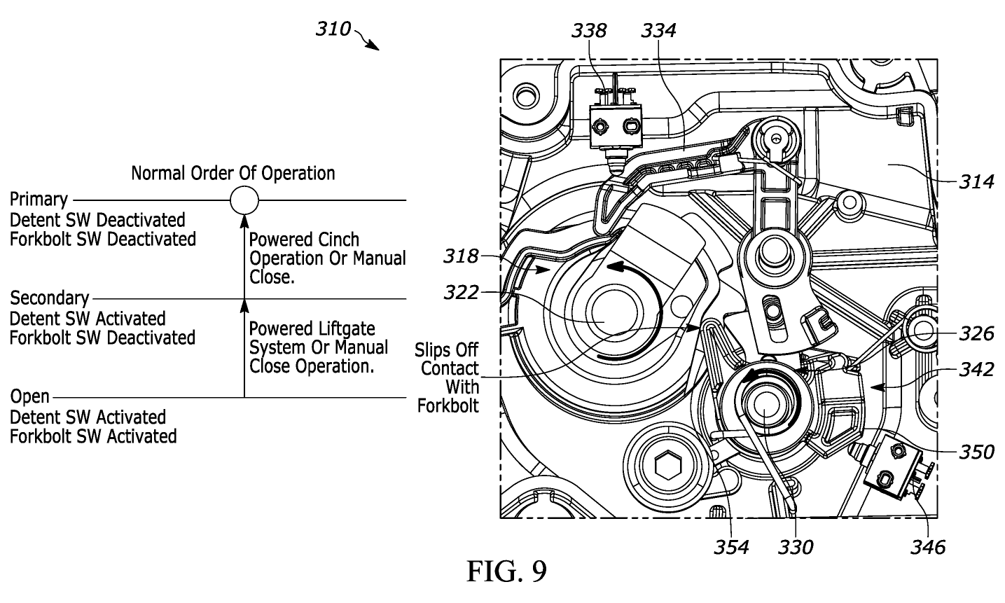

With reference to FIGS. 7-9, the latch assembly 310 may be moved between an open position (FIG. 7), a secondary position (FIG. 8), and a primary position (FIG. 9). In some examples, a powered liftgate system or manual operation may force a striker (e.g., the striker 22) into a fishmouth of the forkbolt 318, causing the latch assembly 310 to move from the open position to the secondary position. A powered cinch operation or a manual close may then move the latch assembly 310 from the secondary position to the primary position. Other examples include different operations and/or conditions that move the latch assembly 310 between the open position, the secondary position, and the primary position. In some examples, one or more of the latch assemblies described herein (e.g., the latch assembly 10 or the latch assembly 310) does not include a fishmouth.

With reference to FIG. 7, when the latch assembly 310 is in the open position, the forkbolt switch 338 and the detent switch 346 are both transitioned to a first state (e.g., an activated state, a deactivated state, or other state), to signify a physical state and status of the latch assembly 310. In this open position, the forkbolt switch lever 334 is pressed against or is otherwise brought into close proximity to the forkbolt switch 338, and the first detent switch lever engagement surface 350 pressed against or is otherwise brought into close proximity to the detent switch 346.

With reference to FIG. 8, the latch assembly 310 may be moved into the secondary position (e.g., by moving the striker 22, such that the striker 22 is captured by the forkbolt 318, and the forkbolt 318 is rotated). When the latch assembly 310 is in the secondary position, and as seen in FIG. 8, the forkbolt switch 338 is transitioned to a second state (e.g., a deactivated state, an activated state, or other state), and the detent switch 346 is transitioned to the first state (e.g., the activated state, the deactivated state, or other state), to signify a different physical state and status of the latch assembly 10. As illustrated in FIG. 8, in this position the second detent switch lever engagement surface 354 is in contact with the forkbolt 318.

With reference to FIG. 9, the latch assembly 310 may be moved into the primary position (e.g., via a cinching operation), and the forkbolt 318 may be rotated further. When the latch assembly 310 is in the primary position, and as seen in FIG. 9, both the forkbolt switch 338 and the detent switch 346 are transitioned to the second state (e.g., the deactivated state, the activated state, or other state), to signify yet a different physical state and status of the latch assembly 10. As illustrated in FIG. 9, in this position the second detent switch lever engagement surface 354 has slipped off of the forkbolt 318, and the first detent switch lever engagement surface 350 is no longer in contact with the detent switch 346.

Other examples of a latch assembly may include other numbers and arrangements of components than those illustrated and described above. For example, while the embodiments described above include the use of both a forkbolt switch lever and a detent switch lever, it is understood that in other examples, a latch assembly may include use of only a single lever (e.g., the detent switch lever) and may not include a forkbolt switch lever. In some examples, a latch assembly may similarly include only a single switch, or more than two switches.

Some of the examples may be further described by reference to the following numbered clauses:

1. A latch assembly comprising:
a forkbolt biased to rotate in a first direction about a first pivot point;
a detent biased to rotate in a second direction about a second pivot point, the detent configured to engage with the forkbolt in at least two different positions;
a detent switch; and
a pivoting detent switch lever having a first detent switch lever engagement surface configured to engage the detent switch during at least one rotational position of the detent switch lever, a second detent switch lever engagement surface configured to engage the detent during at least one rotational position of the detent switch lever, and a third detent switch lever engagement surface configured to engage the forkbolt during at least one rotational position of the detent switch lever.

2. The latch assembly of clause 1, further comprising
a housing, wherein the detent is pivotally coupled to the housing at the first pivot point and
the detent switch lever is pivotally coupled to the housing at a third pivot point that is spaced from the first pivot point.

3. The latch assembly of clause 2, wherein the second pivot point is spaced from both the first pivot point and the third pivot point.

4. The latch assembly of any of the preceding clauses, further comprising a forkbolt switch lever, wherein the forkbolt switch lever is pivotally coupled to an end of the detent.

5. The latch assembly of clause 4, wherein the forkbolt includes a first forkbolt engagement surface configured to contact the forkbolt switch lever.

6. The latch assembly of clause 5, wherein the forkbolt includes a second forkbolt engagement surface configured to contact the detent switch lever.

7. The latch assembly of any of the preceding clauses, wherein detent includes a detent engagement surface, wherein the second detent switch lever engagement surface is configured to contact the detent engagement surface on the detent.

8. The latch assembly of any of the preceding clauses, further comprising a housing, wherein the detent is pivotally coupled to the housing at the first pivot point and the detent switch lever is also pivotally coupled to the housing at the first pivot point.

9. The latch assembly of clause 8, wherein the second pivot point is spaced from the first pivot point.

10. The latch assembly of clause 9, further comprising a forkbolt switch lever, wherein the forkbolt switch lever is coupled to the detent.

11. The latch assembly of clause 10, further comprising a forkbolt switch configured to be contacted by the forkbolt switch lever .

12. The latch assembly of clause 11, wherein the third detent switch lever engagement surface is configured to be spaced from the forkbolt during at least one rotational position of the detent switch lever.

13. The latch assembly of clause 11, wherein both the detent switch and the forkbolt switch are configured to be transitioned to a first state in an open position of the latch assembly, wherein the detent switch is configured to be transitioned to the first state and the forkbolt switch is configured to be transitioned to a second state in a secondary position of the latch assembly, and wherein both the detent switch and the forkbolt switch are configured to be transitioned to the second state in a primary position of the latch assembly, wherein the open position corresponds to a first rotational position of the forkbolt, wherein the secondary position corresponds to a second rotational position of the forkbolt, and wherein the primary position corresponds to a third rotational position of the forkbolt.

14. The latch assembly of any of the preceding clauses, further comprising a detent cushion positioned so as to absorb impact from one end of the detent as the detent is rotated.

15. The latch assembly of any of the preceding clauses, wherein the detent is configured to be rotated about the second pivot point at a first angle when the latch assembly is in a secondary position and at a second angle when the latch assembly is in a primary position, wherein the first angle is equal to the second angle.

16. A latch assembly comprising:
a forkbolt biased to rotate in a first direction about a first pivot point; and
a detent biased to rotate in a second direction about a second pivot point, the detent configured to engage with the forkbolt in at least two different positions;
a detent switch; and
a detent switch lever configured to selectively engage at least one of the detent switch, the forkbolt, and the detent based on a rotational position of the pivoting detent switch lever;
wherein the latch assembly is configured to have an open position corresponding to a first rotational position of the forkbolt, a secondary position corresponding to a second rotational position of the forkbolt, and a primary position corresponding to a third rotational position of the forkbolt;
wherein the detent is configured to be rotated about the second pivot point at a first angle when the latch assembly is in the secondary position and at a second angle when the latch assembly is in the primary position, wherein the first angle is equal to the second angle.

17. The latch assembly of clause 16, further comprising a housing, wherein the detent is pivotally coupled to the housing at the first pivot point and the detent switch lever is pivotally coupled to the housing at a third pivot point that is spaced from the first pivot point.

18. The latch assembly of clause 16 or clause 17, further comprising a housing, wherein the detent is pivotally coupled to the housing at the first pivot point and the detent switch lever is also pivotally coupled to the housing at the first pivot point.

19. The latch assembly of any of clauses 16-18, wherein the detent switch lever is configured to activate the detent switch.

20. The latch assembly of clause 19, further comprising a forkbolt switch lever and a forkbolt switch, wherein the forkbolt switch lever is configured to activate the forkbolt switch.

21. The latch assembly of any of clauses 16-20, further comprising a detent cushion positioned so as to absorb impact from one end of the detent as the detent is rotated.

Although the disclosure has been described in detail with reference to certain preferred embodiments, variations and modifications exist within the scope and spirit of one or more independent aspects of the disclosure as described.

What is claimed is:

1. A latch assembly comprising:
a forkbolt biased to rotate in a first direction about a first pivot point;
a detent biased to rotate in a second direction about a second pivot point, the detent configured to engage with the forkbolt in at least two different positions;
a detent switch; and
a pivoting detent switch lever having a first detent switch lever engagement surface configured to engage the detent switch during at least one rotational position of the detent switch lever, a second detent switch lever engagement surface configured to engage the detent during at least one rotational position of the detent switch lever, and a third detent switch lever engagement surface configured to engage the forkbolt during at least one rotational position of the detent switch lever.

2. The latch assembly of claim 1, further comprising a housing, wherein the detent is pivotally coupled to the housing at the first pivot point and the detent switch lever is pivotally coupled to the housing at a third pivot point that is spaced from the first pivot point.

3. The latch assembly of claim 2, wherein the second pivot point is spaced from both the first pivot point and the third pivot point.

4. The latch assembly of claim 3, further comprising a forkbolt switch lever, wherein the forkbolt switch lever is pivotally coupled to an end of the detent.

5. The latch assembly of claim 4, wherein the forkbolt includes a first forkbolt engagement surface configured to contact the forkbolt switch lever.

6. The latch assembly of claim 5, wherein the forkbolt includes a second forkbolt engagement surface configured to contact the detent switch lever.

7. The latch assembly of claim 6, wherein detent includes a detent engagement surface, wherein the second detent switch lever engagement surface is configured to contact the detent engagement surface on the detent.

8. The latch assembly of claim 1, further comprising a housing, wherein the detent is pivotally coupled to the housing at the first pivot point and the detent switch lever is also pivotally coupled to the housing at the first pivot point.

9. The latch assembly of claim 8, wherein the second pivot point is spaced from the first pivot point.

10. The latch assembly of claim 9, further comprising a forkbolt switch lever, wherein the forkbolt switch lever is coupled to the detent.

11. The latch assembly of claim 10, further comprising a forkbolt switch configured to be contacted by the forkbolt switch lever .

12. The latch assembly of claim 11, wherein the third detent switch lever engagement surface is configured to be spaced from the forkbolt during at least one rotational position of the detent switch lever.

13. The latch assembly of claim 11, wherein both the detent switch and the forkbolt switch are configured to be transitioned to a first state in an open position of the latch assembly, wherein the detent switch is configured to be transitioned to the first state and the forkbolt switch is configured to be transitioned to a second state in a secondary position of the latch assembly, and wherein both the detent switch and the forkbolt switch are configured to be transitioned to the second state in a primary position of the latch assembly, wherein the open position corresponds to a first rotational position of the forkbolt, wherein the secondary position corresponds to a second rotational position of the forkbolt, and wherein the primary position corresponds to a third rotational position of the forkbolt.

14. The latch assembly of claim 1, further comprising a detent cushion positioned so as to absorb impact from one end of the detent as the detent is rotated.

15. The latch assembly of claim 1, wherein the detent is configured to be rotated about the second pivot point at a first angle when the latch assembly is in a secondary position and at a second angle when the latch assembly is in a primary position, wherein the first angle is equal to the second angle.

16. A latch assembly comprising:
a forkbolt biased to rotate in a first direction about a first pivot point;
a detent biased to rotate in a second direction about a second pivot point, the detent configured to engage with the forkbolt in at least two different positions;
a detent switch; and
a detent switch lever configured to selectively engage at least one of the detent switch, the forkbolt, and the detent based on a rotational position of the pivoting detent switch lever;
wherein the latch assembly is configured to have an open position corresponding to a first rotational position of the forkbolt, a secondary position corresponding to a second rotational position of the forkbolt, and a primary position corresponding to a third rotational position of the forkbolt;
wherein the detent is configured to be rotated about the second pivot point at a first angle when the latch assembly is in the secondary position and at a second angle when the latch assembly is in the primary position, wherein the first angle is equal to the second angle.

17. The latch assembly of claim 16, further comprising a housing, wherein the detent is pivotally coupled to the housing at the first pivot point and the detent switch lever is pivotally coupled to the housing at a third pivot point that is spaced from the first pivot point.

18. The latch assembly of claim 16, further comprising a housing, wherein the detent is pivotally coupled to the housing at the first pivot point and the detent switch lever is also pivotally coupled to the housing at the first pivot point.

19. The latch assembly of claim 16, wherein the detent switch lever is configured to activate the detent switch.

20. The latch assembly of claim 19, further comprising a forkbolt switch lever and a forkbolt switch, wherein the forkbolt switch lever is configured to activate the forkbolt switch.

21. The latch assembly of claim 16, further comprising a detent cushion positioned so as to absorb impact from one end of the detent as the detent is rotated.
